(19) United States
(12) Patent Application Publication
(10) Pub. No.: US 2007/0165012 A1
(43) Pub. Date: Jul. 19, 2007

(54) Selection device of items arranged in multi-dimensional manner and cursor movement method thereof

(75) Inventor: Kanta Koda, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/640,492

(22) Filed: Dec. 18, 2006

(30) Foreign Application Priority Data
Dec. 19, 2005 (JP) P2005-364569

(51) Int. Cl. G09G 5/00

(52) U.S. Cl. 345/184

(57) ABSTRACT

According to an embodiment of the invention, a selection device of items arranged in multi-dimensional manner, wherein the items are arranged along a plurality of virtual axes, and each of the items is selectable by a cursor that is movable along the plurality of virtual axes, the selection device comprising: an axis indication unit that indicates a virtual axis to be selected among the plurality of virtual axes, and a movement amount setting unit that sets a moving direction of the cursor along the virtual axis in accordance with a rotation direction thereof and that sets a moving amount of the cursor along the virtual axis in accordance with a rotation amount thereof.

### CROSS-REFERENCE TO RELATED APPLICATIONS

This application is based upon and claims the benefit of priority from Japanese Patent Application No. 2005-364569, filed Dec. 19, 2005, the entire contents of which are incorporated herein by reference.

### BACKGROUND OF THE INVENTION

1. Field of the Invention

The present invention relates to a selection device such as a remote controller that selects items displayed on a screen and a cursor movement method thereof.

2. Background Art As represented by a plasma display or a liquid crystal monitor, as a display device is becoming large in size and has high definition, an amount of information that can be displayed on a screen is increasing. In addition, as a small terminal such as a mobile phone has come into wide use, there has been developed a method of displaying a large amount of information on a limited screen space or a method of making a variety of operation commands, such as indication of display or selective indication of displayed details, with simple and a small number of operations.

An arrow key of a keyboard, a mouse, or the like has served as a known unit that selects a desired item by moving a cursor on a list or the like displayed on a screen. Thereafter, a rotary selection device, such as a jog/shuttle dial, which performs the movement of a cursor or the item selection in a rotational manner not by a button pressing manner has been proposed, and the jog/shuttle dial has been widely adopted in a large number of apparatuses, such as mobile phone terminals or a portable music reproduction apparatuses. In addition, there has been proposed a remote controller capable of properly controlling a counter apparatus, such as a television set, by using a rotary selection device mounted in the remote controller (for example, refer to Japanese Unexamined Patent Application Publication No. 6-350869).

As the information apparatuses have multi-functions, the amount of information displayed on a screen increases, and accordingly, various studies on a display method have been proposed. For example, a menu type display method is generally used in which a desired item is selected from a ‘menu’ and then a submenu related to the selected item is displayed such that selection is made in a hierarchical manner. If three-dimensional display of objects (items) becomes easily realized on a screen with the development of the display device described above (for example, refer to Japanese Unexamined Patent Application Publication No. 2005-65162), it is expected that the display of a variety of objects (items) will be arranged in a three-dimensional manner.

When items are arranged in a three-dimensional or multi-dimensional (higher than three dimension) manner, an operation of selecting the items becomes complicated as compared with that in the case of one-dimensional or two-dimensional arrangement. An explanation on this will be made with reference to the accompanying drawings.

FIG. 1 is a view schematically illustrating a display example of data arranged in a one-dimensional manner and an example of a selection method using a known selection device. For example, in the case of displaying a list of music reproduced by a portable music reproduction apparatus, it is preferable to display the information in the one-dimensional manner. As for the display on a screen shown in FIG. 1, in the related art, it has been possible to move a cursor to an item indicating a desired song title, for example, by rotating a jog dial of the portable music reproduction apparatus left and right.

Next, FIG. 2 is a view schematically illustrating a display example of data arranged in a two-dimensional manner and an example of a selection method using a known selection device. For example, in a portable terminal or a personal computer having a television tuner, information of a program table displayed for reservation recording is displayed in a two-dimensional manner. That is, program information corresponding to a predetermined day is arranged in a two-dimensional matrix where time is set on a vertical axis and television stations (channels) are set on a horizontal axis. As for the display on a screen shown in FIG. 2, in the related art, it has been possible to move a cursor to an item indicating a desired program title, for example, by operating an arrow key (key that can be button-pressed in up and down and left and right directions) provided in a remote controller. At this time, since a several number of key pressing is required to move a cursor to a desired item, there has been a problem in that an operation is troublesome. Moreover, a selection method using a known jog dial in addition to the arrow key may be set. In this case, however, an operation which is pressing of another button is added ((a) and (b) of FIG. 2 show examples thereof), and accordingly, this has also caused a problem in that an operation is troublesome.

Finally, FIG. 3 is a view schematically illustrating a display example of data arranged in a three-dimensional manner. As an example in which information is displayed in a three-dimensional manner, the above program table corresponding to a plurality of days may be arranged. That is, separate program information is arranged in a three-dimensional matrix where time is set on a vertical axis, television channels are set on a horizontal axis, and dates are set in a depth direction. As for the display on a screen shown in FIG. 3, even if a known selection device is a jog dial or an arrow key, key pressing for setting the movement in the ‘depth direction’ (that is, key pressing for setting a date) is required at least once. As a result, a problem occurs in that the number of operations increases, and accordingly, a method of selecting the selection device becomes significantly troublesome. In conclusion, a problem has occurred in that the cursor movement for selection becomes troublesome when selecting items arranged in a multi-dimensional manner.

On the other hand, FIG. 4 is a view illustrating an example of a known menu display in which items are hierarchically displayed such that a user can select a desired item. For example, in a menu for setting of a portable terminal, a main menu is first displayed and then movement to a submenu of a sequentially selected item is made. As shown in FIG. 4, when selection in the order of ‘image quality’ (see (a) of FIG. 4) and ‘contrast’ (see (b) of FIG. 4) is made by using a decision key, a contrast adjustment indicator (see (c) of FIG. 4) is displayed. However, in the known menu type display method, specifically, when a large number of hierarchies exist, a problem has occurred in that it is difficult to see on which hierarchy a current menu is located or it is not possible to directly return from a low-order hierarchical menu to an initial menu screen. For example, in the example shown in FIG. 4, unless a return key is pressed as many as the corresponding number of hierarchies, it is not possible to return to the initial menu screen.

### SUMMARY OF THE INVENTION

According to an embodiment of the invention, A selection device of items arranged in multi-dimensional manner, wherein the items are arranged along a plurality of virtual axes, and each of the items is selectable by a cursor that is movable along the plurality of virtual axes, the selection device comprising: an axis indication unit that indicates a virtual axis to be selected among the plurality of virtual axes; and a movement amount setting unit that sets a moving direction of the cursor along the virtual axis in accordance with a rotation direction-thereof and that sets a moving amount of the cursor along the virtual axis in accordance with a rotation amount thereof.

### BRIEF DESCRIPTION OF THE DRAWINGS

The present invention may be more readily described with reference to the accompanying drawings:

FIG. 1 is a view schematically illustrating a display example of data arranged in a one-dimensional manner and an example of a selection method using a known selection device.

FIG. 2 is a view schematically illustrating a display example of data arranged in a two-dimensional manner and an example of a selection method using a known selection device.

FIG. 3 is a view schematically illustrating a display example of data arranged in a three-dimensional manner.

FIG. 4 is a view illustrating an example of a known menu display in which items are hierarchically displayed such that a user can select a desired item.

FIG. 5 is a block diagram illustrating the internal configuration of a selection device in an example of the invention.

FIG. 6 is a view schematically illustrating the appearance of a selection device in an example of the invention.

FIG. 7 is a view schematically illustrating an example in which a selection device in an example of the invention is mounted in a remote controller.

FIG. 8 is a view schematically illustrating a display example of items that are arranged in a multi-dimensional manner and displayed on a display unit corresponding to a remote controller.

FIG. 9 is a flow chart illustrating procedures of an operation of calculating an amount of cursor movement on a screen, in a remote controller that is mounted with a selection device in an example of the invention.

FIG. 10 is a view schematically illustrating the correspondence relationship between an operation of a selection device mounted in a remote controller and cursor movement on a screen display (X-axis direction).

FIG. 11 is a view schematically illustrating the correspondence relationship between an operation of a selection device mounted in a remote controller and cursor movement on a screen display (Y-axis direction).

FIG. 12 is a view schematically illustrating the correspondence relationship between an operation of a selection device mounted in a remote controller and cursor movement on a screen display (Z-axis direction).

FIG. 13 is a view schematically illustrating the correspondence relationship between an operation of a selection device mounted in a remote controller and menu selection (main menu).

FIG. 14 is a view schematically illustrating the correspondence relationship between an operation of a selection device mounted in a remote controller and menu selection (submenu).

FIG. 15 is a view schematically illustrating the correspondence relationship between an operation of a selection device mounted in a remote controller and menu selection (submenu).

FIG. 16 is a view schematically illustrating a known selection example in a case of searching a desired program by using a genre as the key.

FIG. 17 is a view schematically illustrating the correspondence relationship between an operation of a selection device mounted in a remote controller and television program selection (sports program).

FIG. 18 is a view schematically illustrating the correspondence relationship between an operation of a selection device mounted in a remote controller and television program selection (education program).

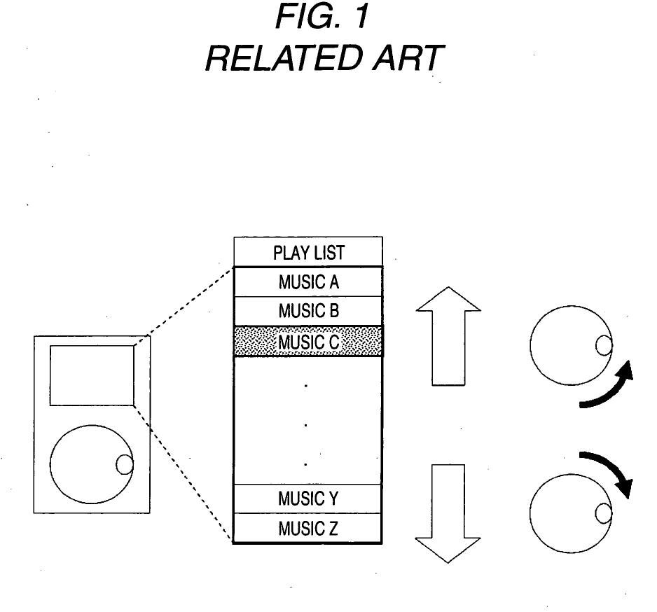

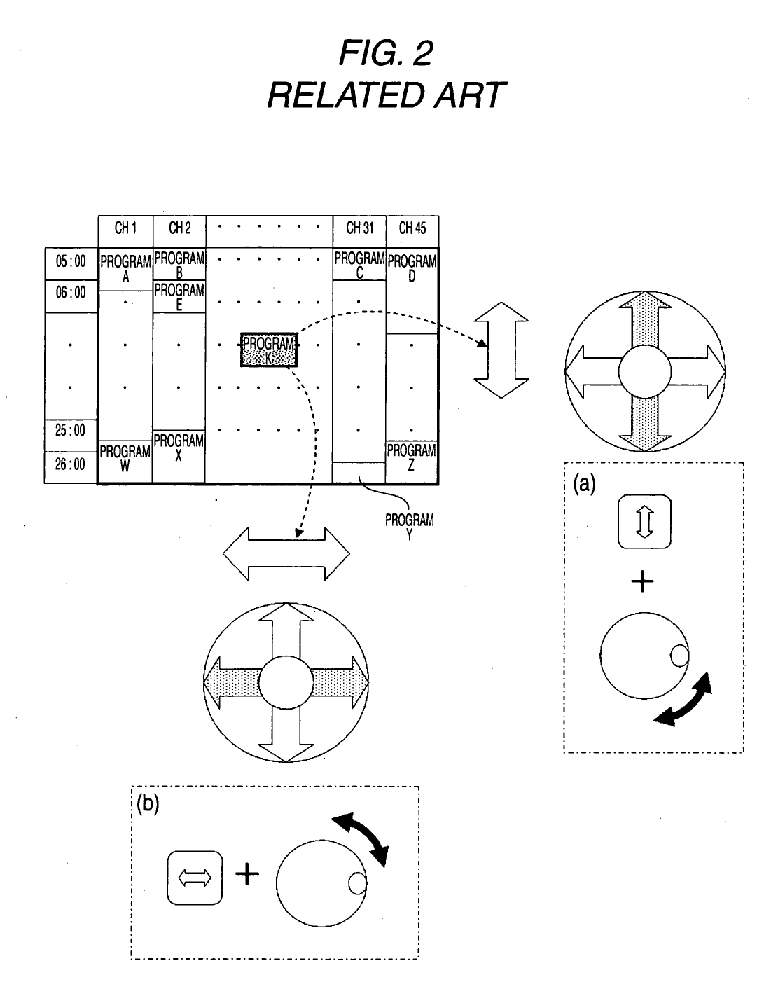

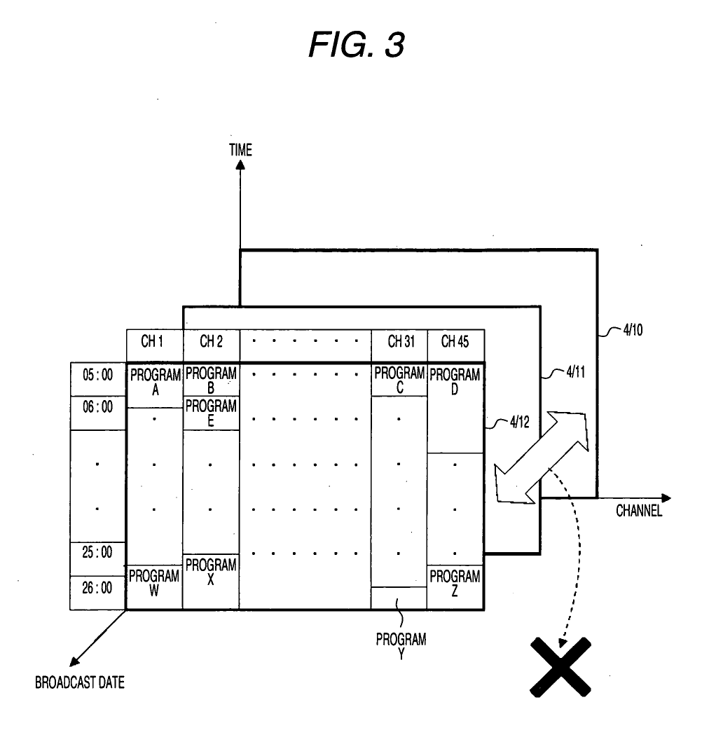

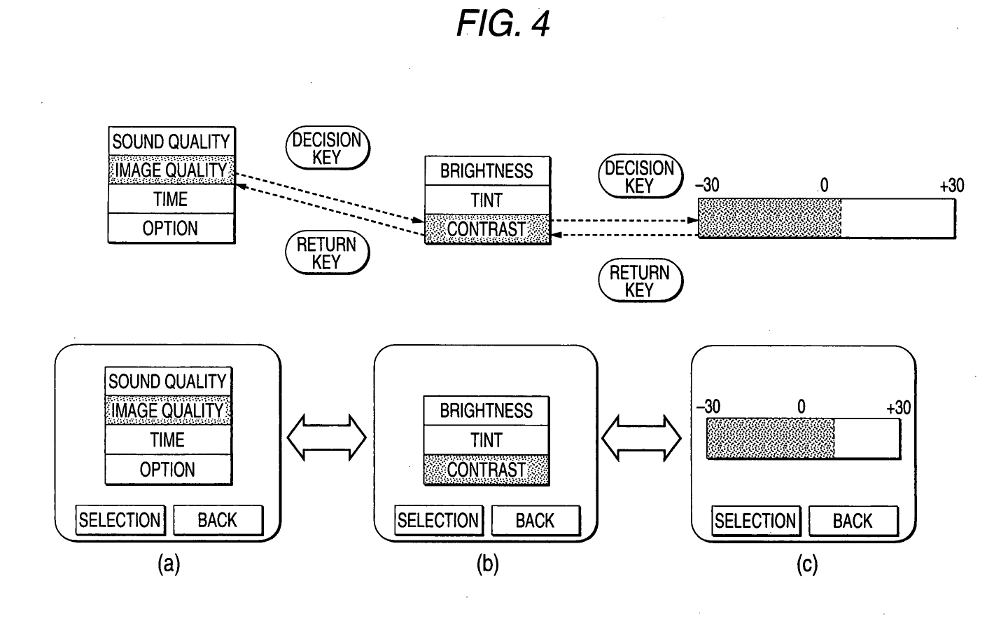

### DETAILED DESCRIPTION OF THE PREFERRED EMBODIMENTS

A most preferred embodiment of a selection device of items arranged in a multi-dimensional manner that items are arranged along a plurality of virtual axes, and each of the items is selectable by a cursor that is movable along the plurality of virtual axes, and a cursor movement method of the selection device is a selection device that selects items arranged in a multi-dimensional manner, and the selection device that selects items arranged in a multi-dimensional manner includes the following (1) and (2).

(1) an axis indication unit that indicates a virtual axis to be selected among the plurality of virtual axes

(2) a movement amount setting unit that sets a moving direction of the cursor along the virtual axis in accordance with a rotation direction thereof and that sets a moving amount of the cursor along the virtual axis in accordance with a rotation amount thereof.

Alternatively, the axis indication unit described in the above (1) may indicate a virtual axis and a direction along which a movement to a desired item is to be made, the virtual axis being one of dimensional axes of the items arranged in the multi-dimensional manner. In this case, the unit for indication of an amount of movement described in the above (2) indicates an amount of movement along the indicated virtual axis and the direction in accordance with an amount of rotation.

Thus, by indicating the movement direction according to a virtual axis and indicating direction and amount of the movement in the selected movement direction in accordance with the direction and amount of rotation, the movement of a cursor for selecting the items arranged in the multi-dimensional manner can be easily and precisely performed while viewing the display. In addition, since the indication of movement direction according to a virtual axis can be performed whenever necessary, the movement of a cursor can be performed quickly and precisely.

Hereinafter, a selection device for selecting items arranged in a multi-dimensional manner and a cursor movement method thereof according to a most preferred embodiment of the invention will be described by way of specific examples with reference to the accompanying drawings.

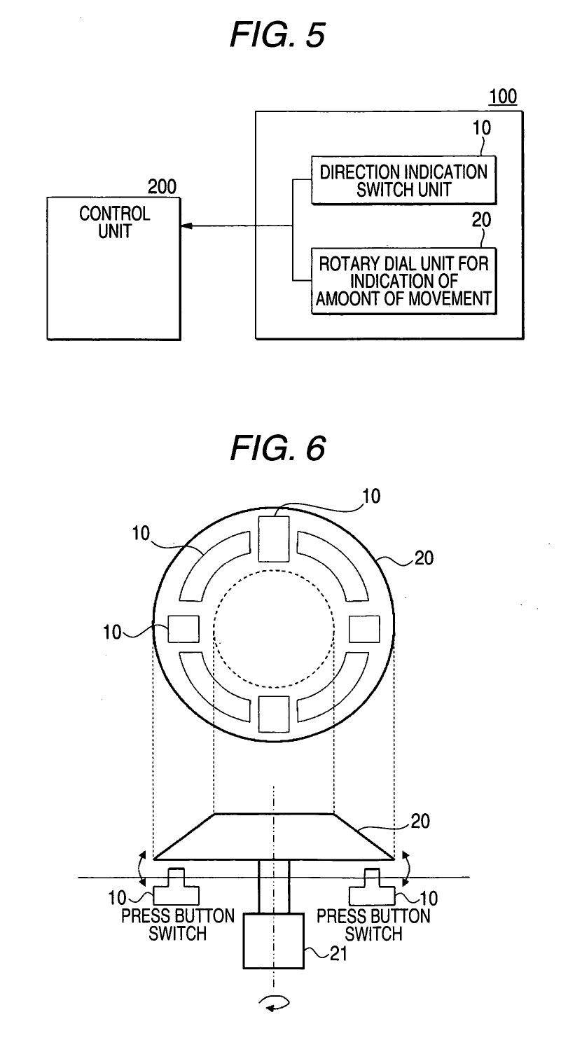

FIG. 5 is a block diagram illustrating the internal configuration of a selection device in an example of the invention. As shown in FIG. 5, a selection device 100 mainly includes a direction indication switch unit (axis indication unit) 10 and a rotary dial unit for indication of an amount of movement (movement amount setting unit) 20. Detected information on pressing of the direction indication switch unit 10 and rotation direction and an amount of rotation of the rotary dial unit for indication of an amount of movement 20 are transmitted to a control unit 200 of an apparatus.

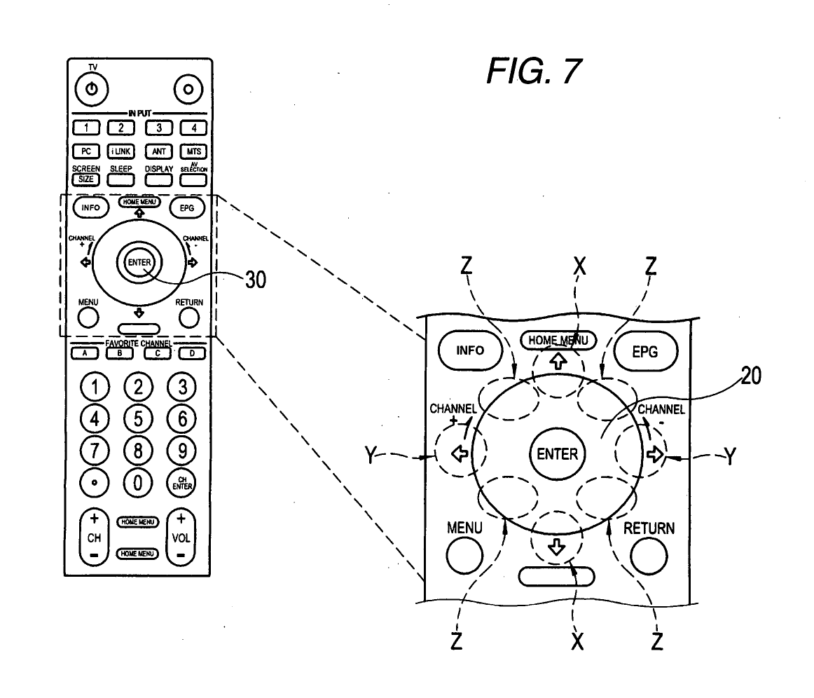

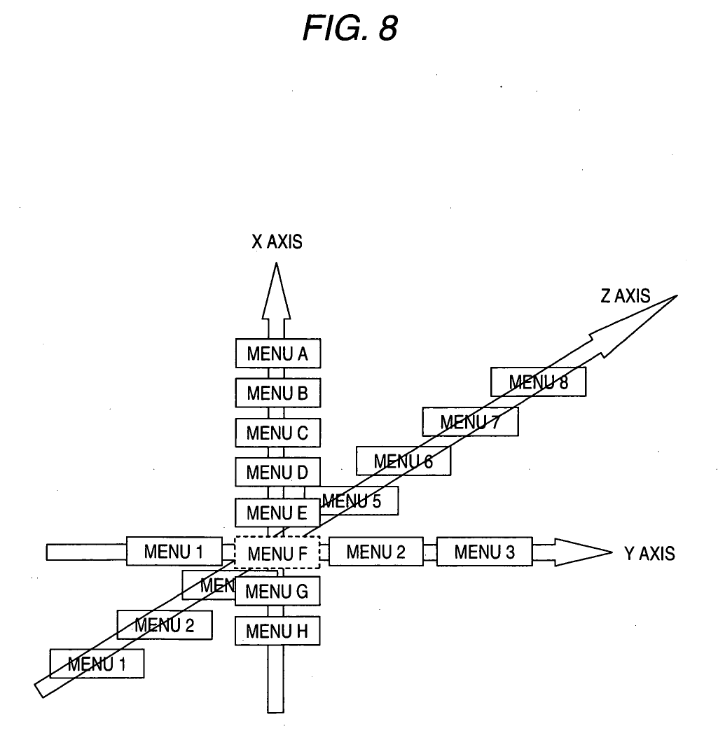

FIG. 6 is a view schematically illustrating the appearance of a selection device in an example of the invention. FIG. 7 is a view schematically illustrating an example in which a selection device in an example of the invention is mounted in a remote controller. FIG. 8 is a view schematically illustrating a display example of items that are arranged in a multi-dimensional manner and displayed on a display unit (not shown; for example, a display device) corresponding to a remote controller 300.

As shown in FIG. 6, in the selection device 100, the press-button-type direction indication switch unit 10 is disposed below the rotary dial unit for indication of an amount of movement 20 in eight directions including up and down directions, left and right directions, and inclined directions. The rotary dial unit for indication of an amount of movement 20 is configured to be able to be inclined by a small angle, and the direction indication switch unit 10 can be pressed at the edge of an inclined dial.

Further, the rotary dial unit for indication of an amount of movement 20 is rotatably hold on a main body (refer to FIG. 7) of the remote controller 300.

In addition, the selection device 100 includes a rotation detecting unit 21, which serves as a unit that detects the rotation direction and the amount of rotation of the rotary dial unit for indication of an amount of movement 20, below the rotary dial unit for indication of an amount of movement 20, and the detected rotation direction and amount of rotation are transmitted to the control unit 200 of the apparatus.

In the selection device in the example of the invention, it is possible to precisely and quickly perform the cursor movement for selecting items arranged in a multi-dimensional manner by means of pressing of buttons disposed at eight places. For example, by separating the buttons into three kinds of buttons (upper and lower buttons, left and right buttons, and inclined buttons (upper left, upper right, lower left, and lower right buttons)) and assigning the three kinds of buttons for the movement directions corresponding to respective dimensional axes of items arranged in the three-dimensional manner, it is possible to indicate the movement directions corresponding to the respective dimensional axes of items arranged in the three-dimensional manner as an X axis, a Y axis, a Z axis, or the like. A specific example of assignment of the movement direction will be described later.

As shown in FIG. 7, in the remote controller 300, pressing of upper and lower portions (regions surrounded by a dotted line indicated by ‘X’ in the drawing) of the rotary dial unit for indication of an amount of movement 20 is set to correspond to selection of the X axis on a three-dimensional menu display shown in FIG. 8. Further, pressing of left and right portions (regions surrounded by a dotted line indicated by ‘Y’ in the drawing) of the rotary dial unit for indication of an amount of movement 20 is set to correspond to selection of the Y axis on the three-dimensional menu display shown in FIG. 8. In the same manner, pressing of left and right portions (regions surrounded by a dotted line indicated by ‘Z’ in the drawing) of the rotary dial unit for indication of an amount of movement 20 is set to correspond to selection of the Z axis on the three-dimensional menu display shown in FIG. 8.

In addition, the rotation direction and the amount of rotation of the rotary dial unit for indication of an amount of movement 20 are set to correspond to a rotation direction and an amount of rotation in the movement direction corresponding to the selected virtual axis. In addition, in the remote controller, an ENTER key 30 used to decide the selection is disposed at a central portion of the rotary dial unit for indication of an amount of movement 20.

Next, an operation of the selection device having the configuration described above will be described. Here, a control operation of the remote controller 300, which is mounted with a selection device, according to the cursor movement will be described, since the selection operation performed by the selection device is reflected on the cursor movement on a screen.

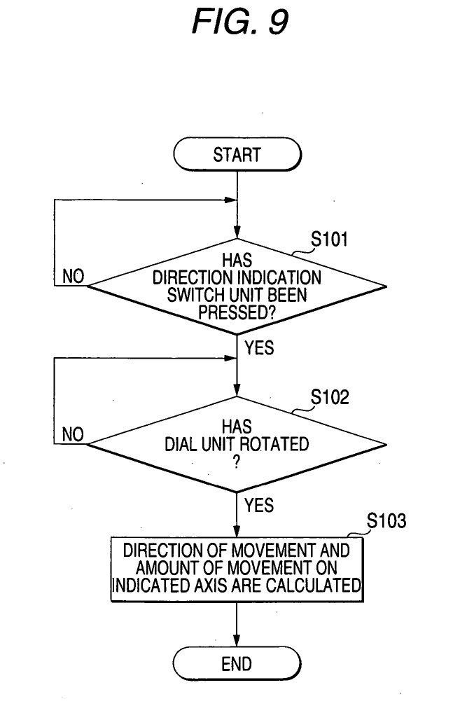

FIG. 9 is a flow chart illustrating procedures of an operation of calculating an amount of cursor movement on a screen, in a remote controller that is mounted with the selection device in the example of the invention. First, the control unit 200 of the remote controller 300 determines the pressing of the direction indication switch unit 10 (step S101). If it is determined that the movement direction corresponding to a virtual axis has been indicated by the pressing of a button (YES in step S101), the control unit 200 of the remote controller 300 determines rotation of the rotary dial unit for indication of an amount of movement 20 (step S102). If the rotation is detected (YES in step S102), the direction and amount of cursor movement on the indicated axis are calculated on the basis of information according to the rotation direction and the amount of rotation.

Further, the control unit 200 of the remote controller 300 performs a display process of changing the position of a cursor according to a result of the calculation. Furthermore, selection of a corresponding item is confirmed by pressing the ENTER key 30 at the desired cursor position.

Hereinafter, it will be described in detail how the cursor position moves on the three-dimensional menu display shown in FIG. 8 by means of the operation of the selection device 100 mounted in the remote controller 300.

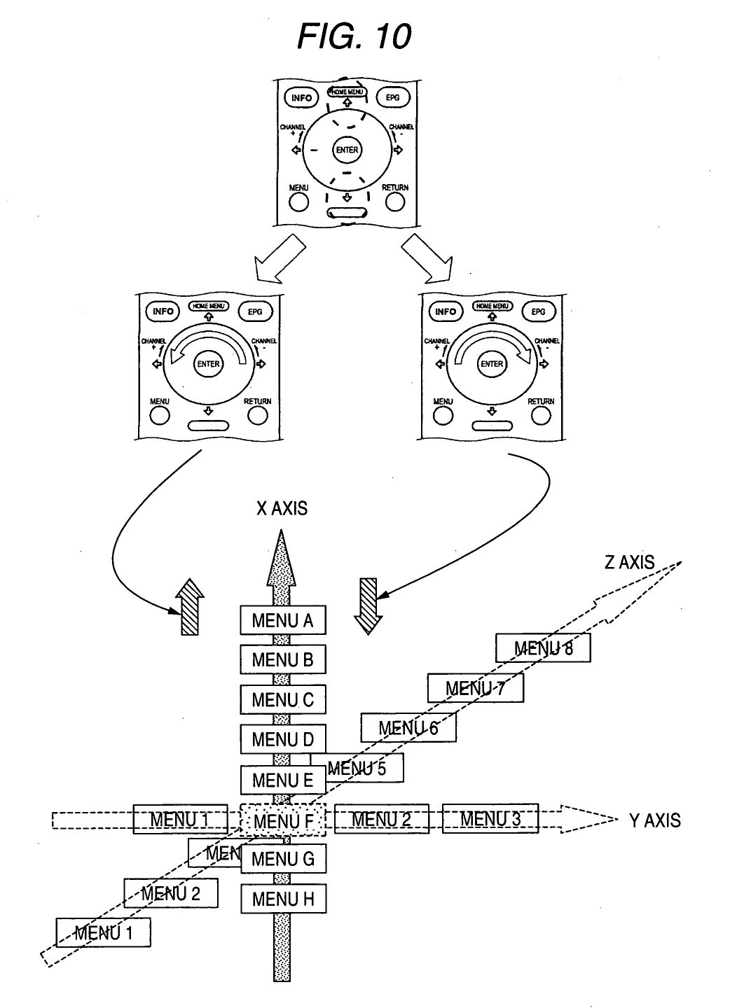

FIGS. 10 to 12 are views schematically illustrating the correspondence relationship between an operation of a selection device mounted in a remote controller and cursor movement on a screen display. As shown in FIG. 10, when pressing any one of upper and lower portions of the rotary dial unit for indication of an amount of movement 20 and then rotating the rotary dial unit for indication of an amount of movement 20 in the left direction, a cursor moves upward on a menu arranged along the X axis. On the other hand, when pressing any one of the upper and lower portions of the rotary dial unit for indication of an amount of movement 20 and then rotating the rotary dial unit for indication of an amount of movement 20 in the right direction, the cursor moves downward on the menu arranged along the X axis.

In the example described above, the movement direction (up and down direction) of the cursor is set to be determined by the rotation direction of the rotary dial unit for indication of an amount of movement 20. However, for example, it may be set such that when the upper portion of the rotary dial unit for indication of an amount of movement 20 is pressed, the cursor moves upward regardless of subsequent rotation direction of the dial and when the lower portion of the rotary dial unit for indication of an amount of movement 20 is pressed, the cursor moves downward regardless of the subsequent rotation direction of the dial.

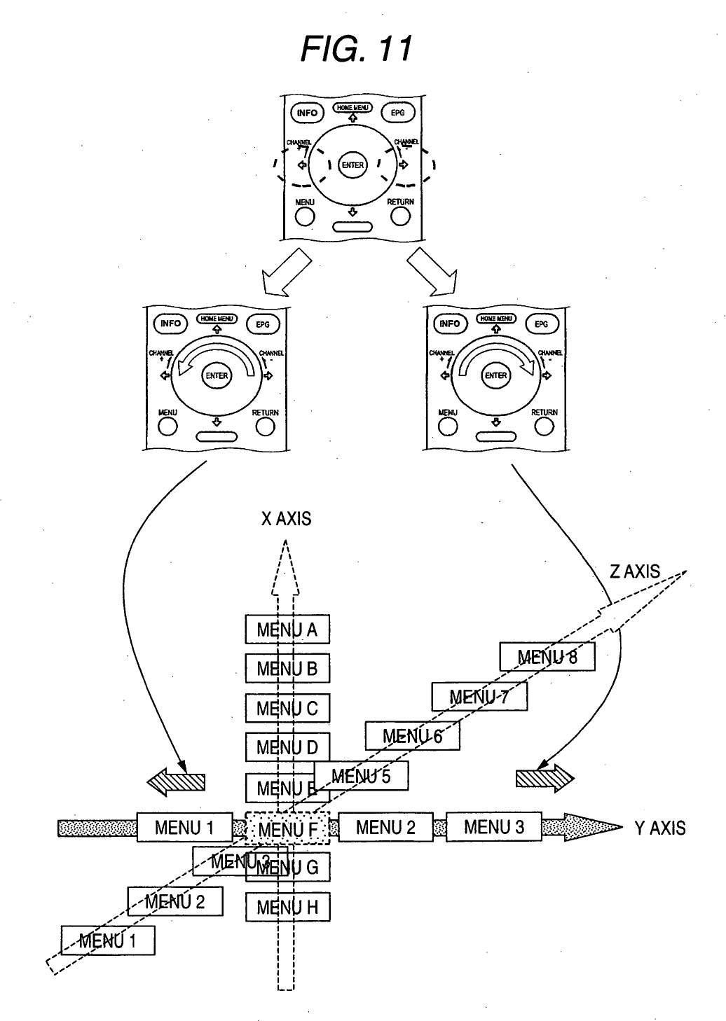

Then, as shown in FIG. 11, when pressing any one of left and right portions of the rotary dial unit for indication of an amount of movement 20 and then rotating the rotary dial unit for indication of an amount of movement 20 in the left direction, the cursor moves leftward on a menu arranged along the Y axis. On the other hand, when pressing any one of the left and right portions of the rotary dial unit for indication of an amount of movement 20 and then rotating the rotary dial unit for indication of an amount of movement 20 in the right direction, the cursor moves rightward on the menu arranged along the Y axis.

In the example described above, the movement direction (left and right direction) of the cursor is set to be determined by the rotation direction of the rotary dial unit for indication of an amount of movement 20. However, for example, it may be set such that when the left portion of the rotary dial unit for indication of an amount of movement 20 is pressed, the cursor moves leftward regardless of subsequent rotation direction of the dial and when the right portion of the rotary dial unit for indication of an amount of movement 20 is pressed, the cursor moves rightward regardless of the subsequent rotation direction of the dial.

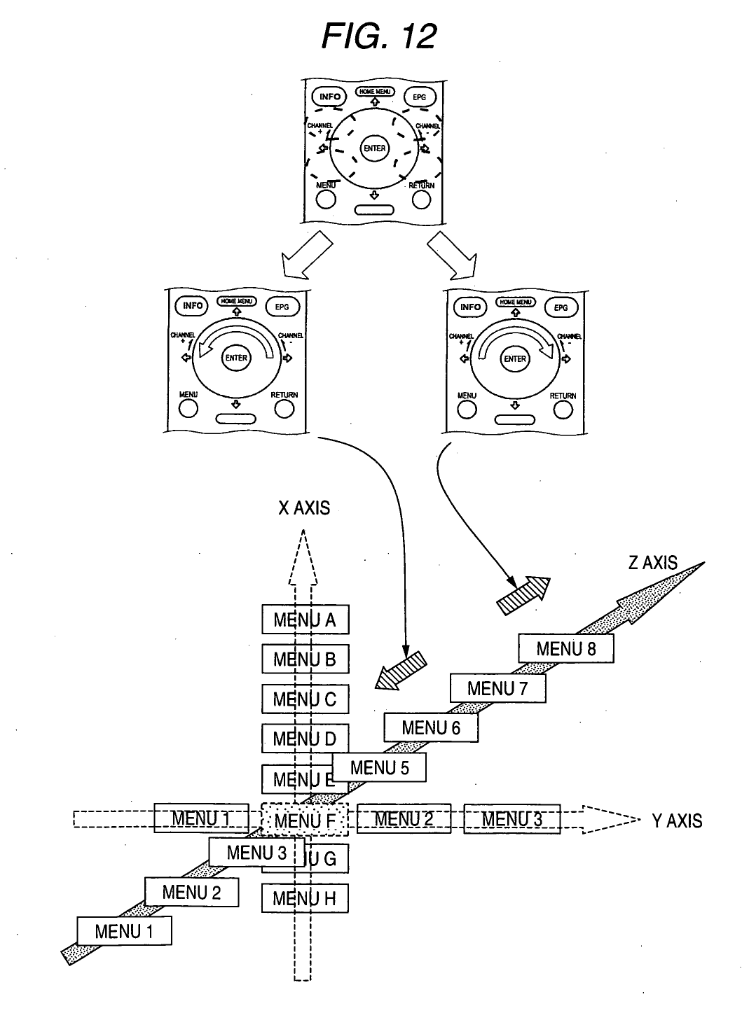

Then, as shown in FIG. 12, when pressing any one of upper left, upper right, lower left, and lower right portions of the rotary dial unit for indication of an amount of movement 20 and then rotating the rotary dial unit for indication of an amount of movement 20 in the left direction, the cursor moves forward on a menu arranged along the Z axis. On the other hand, when pressing any one of the upper left, upper right, lower left, and lower right portions of the rotary dial unit for indication of an amount of movement 20 and then rotating the rotary dial unit for indication of an amount of movement 20 in the right direction, the cursor moves backward on the menu arranged along the Z axis.

In the example described above, the movement direction (back and forth direction) of the cursor is set to be determined by the rotation direction of the rotary dial unit for indication of an amount of movement 20. However, for example, it may be set such that when the lower left portion of the rotary dial unit for indication of an amount of movement 20 is pressed, the cursor moves forward regardless of subsequent rotation direction of the dial and when the upper right portion of the rotary dial unit for indication of an amount of movement 20 is pressed, the cursor moves backward regardless of the subsequent rotation direction of the dial.

Hereinafter, procedures of item selection performed by the selection device 100 mounted in the remote controller 300 will be described in detail by the use of an actual display example. Here, it will be described about a case in which adjustment of contrast is performed by using a preset ‘three-dimensional menu for apparatus setting’. On this menu, a submenu with respect to a main menu arranged on the X axis is arranged in the order of Y and Z axes.

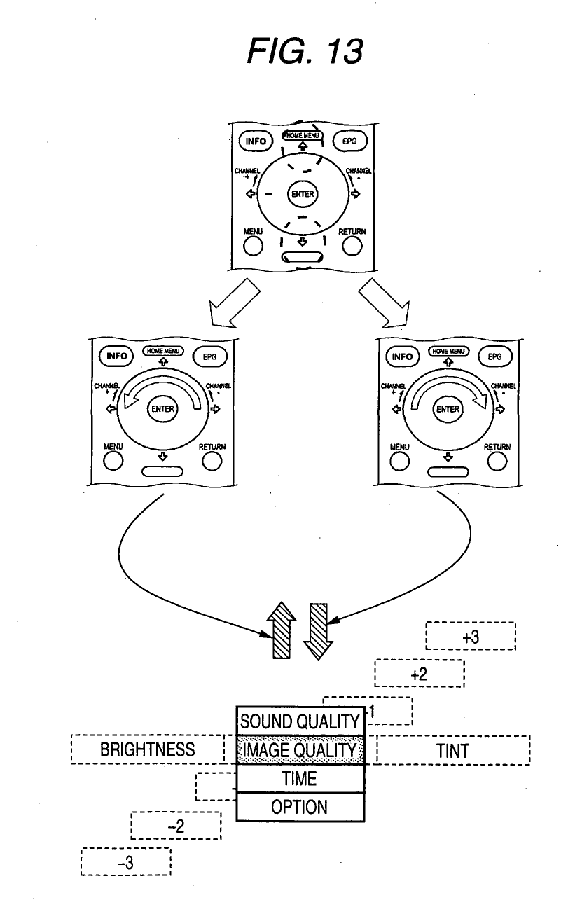

FIGS. 13 to 15 are views schematically illustrating the correspondence relationship between an operation of a selection device mounted in a remote controller and menu selection. As shown in FIG. 13, first, when a main menu arranged on the X axis (axis in the up and down direction) is displayed, a desired option is selected from the main menu. For example, the cursor is positioned at ‘image quality’ by pressing any one of the upper and lower portions of the rotary dial unit for indication of an amount of movement 20 of the remote controller 300 and then properly rotating the rotary dial unit for indication of an amount of movement 20.

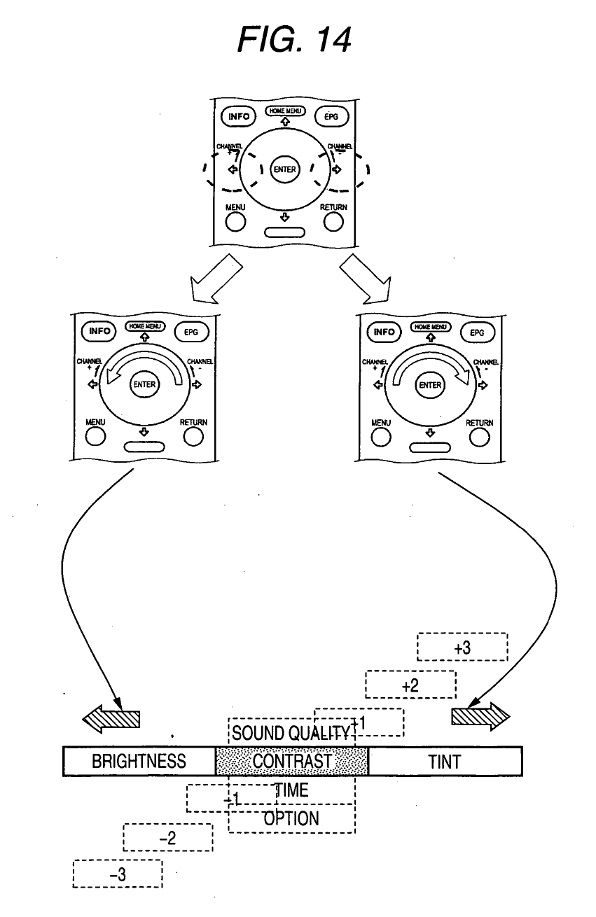

Thereafter, by pressing any one of the right and left portions of the rotary dial unit for indication of an amount of movement 20 of the remote controller 300 under the state in which the cursor is positioned at the ‘image quality’, a submenu related to the ‘image quality’ is arranged and displayed in the Y axis (axis in the left and right direction), as shown in FIG. 14. Then, the cursor is positioned at the ‘contrast’ by properly rotating the rotary dial unit for indication of an amount of movement 20.

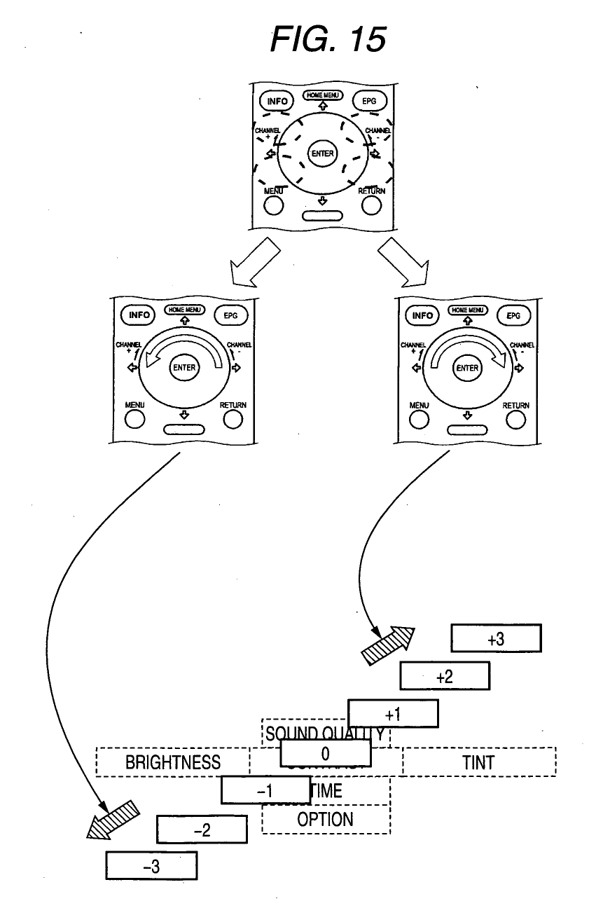

Thereafter, by pressing any one of the upper left, upper right, lower left, and lower right portions of the rotary dial unit for indication of an amount of movement 20 of the remote controller 300 under the state in which the cursor is positioned at the ‘contrast’, indicator serving as a submenu related to the ‘contrast’ is arranged and displayed in the Z axis (axis in the depth direction), as shown in FIG. 15. Then, the cursor is positioned at the desired ‘contrast’ by properly rotating the rotary dial unit for indication of an amount of movement 20. When pressing the ENTER key 30 at the location where the cursor has been positioned, the setting is confirmed.

Moreover, as shown in FIGS. 13 to 15, a menu related to a virtual axis that is currently selected is explicitly displayed so as to be distinguished from other items. A display method is not limitative but various display methods may be used. For example, the distinction may be made by highlighting only a selectable menu with a color and by gray-displaying items related to the other menus.

Furthermore, in the remote controller 300 in the example, even under a display state of a value setting performed by, for example, the indicator shown in FIG. 15, it is possible to immediately return to the menu display of the main menu shown in FIG. 13 by pressing any one of the ‘upper and lower portions’ of the rotary dial unit for indication of an amount of movement 20. Accordingly, unlike in the related art, without performing troublesome operations for returning from a low-order hierarchy to a high-order hierarchy by pressing a ‘return’ key several times, it is possible to precisely and quickly select items (menu or submenu) arranged in the multi-dimensional manner.

Next, procedures of the item selection performed by the selection device 100 mounted in the remote controller 300 will be described in detail by the use of another actual display example. Here, it will be described about an example in which a desired program is searched (selected) from a television program table, which is arranged in the three-dimensional manner, by using a genre as the key. In this menu, program information corresponding to each genre menu, which is arranged on the Z axis, is arranged on the X-Y plane on the basis of time and channel.

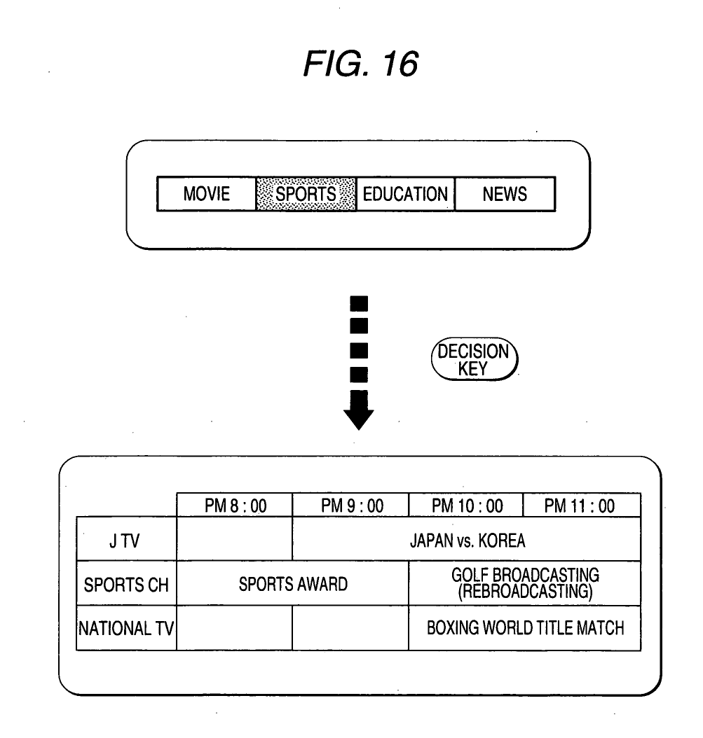

Next, a known selection example will be described. FIG. 16 is a view schematically illustrating a known selection example in a case of searching a desired program by using a genre as the key. As shown in FIG. 16, when a desired genre is selected on an initial screen display and then a decision key is pressed, only programs corresponding to the desired genre are extracted from preset television programs on a predetermined date and are then displayed.

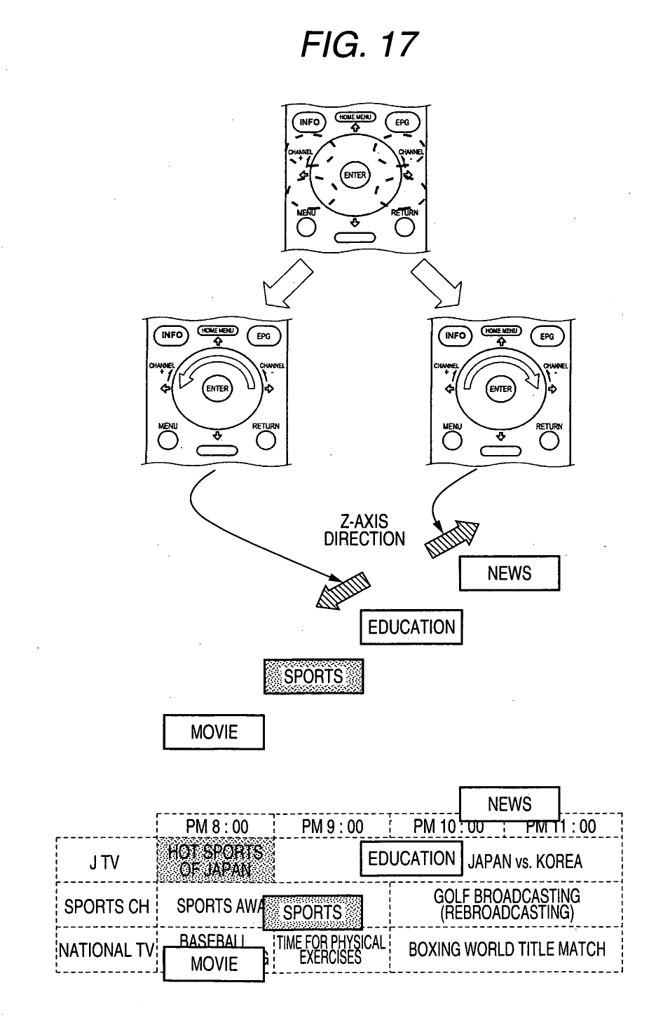

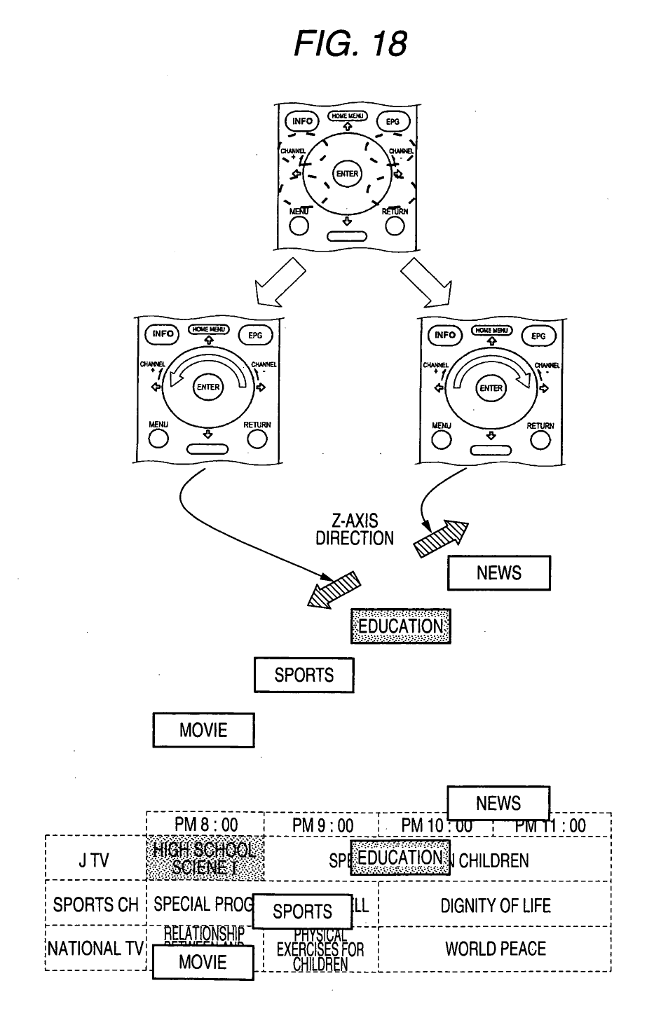

In addition, FIGS. 17 to 18 are views schematically illustrating the correspondence relationship between an operation of a selection device mounted in a remote controller and television program selection. As shown in FIG. 17, first, when a genre menu arranged on the Z axis (axis in the depth direction) is displayed, a desired genre is selected from the genre menu. For example, the cursor is positioned at ‘sports’ by pressing any one of the upper left, upper right, lower left, and lower right portions of the rotary dial unit for indication of an amount of movement 20 of the remote controller 300 and then properly rotating the rotary dial unit for indication of an amount of movement 20.

Then, when pressing any one of the upper and lower portions or left and right portions of the rotary dial unit for indication of an amount of movement 20 of the remote controller 300 under the state in which the cursor is positioned at the ‘sports’, a program table obtained by extracting only programs related to the ‘sports’ is displayed, as shown in FIG. 17. Then, by properly rotating the rotary dial unit for indication of an amount of movement 20 after pressing any one of the upper and lower portions or left and right portions of the rotary dial unit for indication of an amount of movement 20, it is possible to make the cursor positioned at a desired program. When pressing the ENTER key 30 at the location where the cursor has been positioned, the selection of a program is confirmed.

In the same manner, as shown in FIG. 18, the cursor is positioned at ‘education’ by pressing any one of the upper left, upper right, lower left, and lower right portions of the rotary dial unit for indication of an amount of movement 20 of the remote controller 300 and then properly rotating the rotary dial unit for indication of an amount of movement 20.

Then, when pressing any one of the upper and lower portions or the left and right portions of the rotary dial unit for indication of an amount of movement 20 of the remote controller 300 under the state in which the cursor is positioned at the ‘education’, a program table obtained by extracting only programs related to the ‘education’ is displayed, as shown in FIG. 18. Then, by properly rotating the rotary dial unit for indication of an amount of movement 20 after pressing any one of the upper and lower portions or left and right portions of the rotary dial unit for indication of an amount of movement 20, it is possible to make the cursor positioned at a desired program. When pressing the ENTER key 30 at the location where the cursor has been positioned, the selection of a program is confirmed.

In addition, as shown in FIGS. 17 to 18, a ‘genre’ (menu on the Z axis) that is currently selected is explicitly displayed so as to be distinguished from other items. In addition, ‘program title’ (item arranged on the X-Y plane in the two-dimensional manner) that is currently selected is explicitly displayed so as to be distinguished from other program titles. A display method is not limitative but various display methods may be used. For example, the distinction may be made by highlighting only a genre or a program title that is currently selected with a color and by gray-displaying other genres or program titles.

Furthermore, in the remote controller 300 in the example, even under a display state of a program table obtained by extracting, for example, only ‘sports’ programs shown in FIG. 17, it is possible to immediately highlight a selectable genre menu by pressing any one of the upper left, upper right, lower left, and lower right portions of the rotary dial unit for indication of an amount of movement 20. Accordingly, for example, by selecting the ‘education’, it is possible to move to a display state of a program table obtained by extracting only ‘education’ programs shown in FIG. 18. As a result, unlike in the related art, without performing troublesome operations in which the ‘return key’ is pressed to return to the main menu and then a genre is selected again, it is possible to precisely and quickly select items (genres and program information arranged in the two-dimensional manner) arranged in the multi-dimensional manner.

According to the selection method using the selection device in the example, the selection can be performed while viewing the entire two-dimensional display in the case of a menu arranged in the two-dimensional manner or while viewing the entire three-dimensional display in the case of a menu arranged in the three-dimensional manner, for example. As a result, it is possible to easily and precisely see to which hierarchy the current position of a cursor belongs. Thus, in the selection method in the example, it is possible to perform the selection precisely and quickly while viewing the entire items arranged in the multi-dimensional manner, as compared with the known menu type selection method in which only a submenu belonging to a corresponding hierarchy is displayed due to restrictions of a selection device.

Further, in the example described above, the buttons of the direction indication switch unit 10 have been assigned such that the up and down direction corresponds to the X axis of the three-dimensional space, the left and right direction corresponds to the Y axis, and the depth direction corresponds to the Z axis. However, the invention is not limited thereto. For example, the correspondence relationship between the direction indication switch unit 10 and the movement direction according to a virtual axis of the multi-dimensional arrangement may be arbitrarily set. Here, as shown in the example described above, it is preferable that the correspondence relation be intuitively perceived from a screen display (for example, in the case when a cursor needs to move in the up and down direction, the upper and lower buttons are assigned for the movement direction, or in the case when the cursor needs to move in the left and right direction, the left and right buttons are assigned for the movement direction.

Furthermore, in the example described above, it has been described about an example of the cursor movement in the case of selecting the items arranged in the three-dimensional manner. However, the invention is not limited thereto. Even though a study on the display on a screen is needed, the movement of a cursor for selecting items arranged in a four or more dimensional manner can also be properly and quickly made by the pressing and rotation of a dial described above. In this case, the movement direction according to a virtual axis needs to be properly assigned to each of the buttons, which are disposed at the eight places, of the direction indication switch unit 10.

As described in detail above, the selection device 100 in the example of the invention is a selection device used to select items arranged in the multi-dimensional manner. In addition, the selection device 100 includes: the direction indication switch unit 10 serving as a axis indication unit that indicates a virtual axis, along which a movement to a desired item is to be made, among dimensional axes of the items arranged in the multi-dimensional manner; and the rotary dial unit for indication of an amount of movement 20 serving as a unit for indication of an amount of movement that indicates direction and amount of movement along the indicated virtual axis in accordance with direction and amount of rotation, respectively. In addition, the selection device 100 selects an item by means of a cooperative operation between the direction indication switch unit 10 and the rotary dial unit for indication of an amount of movement 20.

For example, on a menu arranged in the multi-dimensional manner in which a submenu related to a main menu arranged on the X axis is positioned along the Y and Z axes, it is possible to move a cursor on the corresponding virtual axis by selecting, the virtual axis by means of the direction indication switch unit 10 and then performing the dial rotation of the rotary dial unit for indication of an amount of movement 20. As such, the cursor movement for select the items arranged in the multi-dimensional manner can be easily and precisely performed while viewing the display. In addition, since the indication of movement direction according to a virtual axis can be performed, whenever necessary, by pressing the direction indication switch unit 10, the movement of a cursor can be performed quickly and precisely.

As described with reference to the embodiment, there is provided a selection device capable of easily and precisely performing the cursor movement for selecting items arranged in a multi-dimensional manner while viewing a display. Further, there is provided a selection device capable of quickly and precisely performing the cursor movement by allowing the indication of movement direction according to a dimensional axis to be performed whenever necessary.

What is claimed is:

1. A selection device of items arranged in multi-dimensional manner, wherein the items are arranged along a plurality of virtual axes, and each of the items is selectable by a cursor that is movable along the plurality of virtual axes, the selection device comprising:
an axis indication unit that indicates a virtual axis to be selected among the plurality of virtual axes; and
a movement amount setting unit that sets a moving direction of the cursor along the virtual axis in accordance with a rotation direction thereof and that sets a moving amount of the cursor along the virtual axis in accordance with a rotation amount thereof.

2. A selection device of items arranged in multi-dimensional manner, wherein the items are arranged along a plurality of virtual axes, and each of the items is selectable by a cursor that is movable along the plurality of virtual axes, the selection device comprising:
an axis indication unit that indicates a virtual axis and a moving direction of the cursor along the virtual axis, wherein the virtual axis is selected among the plurality of virtual axes; and
a movement amount setting unit that sets a moving amount of the cursor along the virtual axis in accordance with a rotation amount thereof.

3. The selection device according to claim 1, wherein
the axis indication unit indicates the virtual axis regardless of a current position of the cursor.

4. The selection device according to claim 2, wherein
the axis indication unit indicates the virtual axis regardless of a current position of the cursor.

5. A remote controller comprising:
a selection device of items arranged in multi-dimensional manner;
wherein the items are arranged along a plurality of virtual axes;
each of the items is selectable by a cursor that is movable along the plurality of virtual axes; and
the selection device comprises:
an axis indication unit that indicates a virtual axis to be selected among the plurality of virtual axes; and
a movement amount setting unit that sets a moving direction of the cursor along the virtual axis in accordance with a rotation direction and that sets a moving amount of the cursor along the virtual axis in accordance with a rotation amount thereof.

6. A remote controller comprising:
a selection device of items arranged in multi-dimensional manner;
wherein the items are arranged along a plurality of virtual axes;
each of the items is selectable by a cursor that is movable along the plurality of virtual axes;
the selection device comprises:
an axis indication unit that indicates a virtual axis and a moving direction of the cursor along the virtual axis; wherein the virtual axis is selected among the plurality of virtual axes; and
a movement amount setting unit that sets a moving amount of the cursor along the virtual axis in accordance with a rotation amount thereof.

7. The remote controller according to claims 5,
wherein the axis indication unit indicates the virtual axis regardless of a current position of the cursor.

8. The remote controller according to claims 6,
wherein the axis indication unit indicates the virtual axis regardless of a current position of the cursor.

9. A cursor movement method of a selection device of items arranged in multi-dimensional manner, wherein the items are arranged along a plurality of virtual axes and each item is selectable by cursor that is movable along the plurality of virtual axes, the cursor movement method comprising:
indicating a virtual axis to be selected among the plurality of virtual axes;
setting a moving direction and a moving amount of the cursor along the virtual axis in accordance with a rotation direction and a rotation amount thereof; and
selecting one of the items arranged along the 1indicated axis.

10. A cursor movement method of a selection device of items arranged in multi-dimensional manner, wherein the items are arranged along a plurality of virtual axes and each item is selectable by cursor that is movable along the plurality of virtual axes, the cursor movement method comprising:
indicating a virtual axis and a moving direction of the cursor along the virtual axis, wherein the virtual axis is selected among the plurality of virtual axes;
setting a moving amount of the cursor along the virtual axis in accordance with a rotation amount thereof; and
selecting one of the items arranged along the indicated axis.

11. A cursor movement method according claim 9, wherein, the indicating step includes indicating the virtual axis regardless of a current position of the cursor.

12. A cursor movement method according claim 10, wherein, the indicationg step includes indicating the virtual axis regardless of a current position of the cursor.
